(19) United States
(12) Patent Application Publication
(10) Pub. No.: US 2026/0205006 A1
(43) Pub. Date: Jul. 16, 2026

(54) Ripple Reduction Circuit, Power Supply Circuit and Smart Meter

(71) Applicant: Joulwatt Technology Co., Ltd., Hangzhou (CN)

(72) Inventor: Pitleong Wong, Hangzhou (CN)

(21) Appl. No.: 19/442,767

(22) Filed: Jan. 7, 2026

(30) Foreign Application Priority Data
Jan. 10, 2025 (CN) 202510039295.1

(51) Int. Cl. H02M 1/15; H02M 1/00; H02M 1/08; H02M 3/157; H02M 7/217

(52) U.S. Cl. CPC H02M 1/15; H02M 1/0025; H02M 1/08; H02M 3/157; H02M 7/2176

(57) ABSTRACT

This application discloses a ripple reduction circuit, a power supply circuit, and a smart meter. A DC voltage with ripple is processed by the ripple reduction circuit for ripple reduction to obtain a low-ripple DC output voltage. The ripple reduction circuit includes a power switch and an error amplifier circuit. The error amplifier circuit is configured to control the power switch based on an error amplification result of the DC output voltage and a reference voltage, thereby outputting a desired output voltage. The reference voltage is adjustable in real time according to the magnitude of the DC voltage. This ripple reduction scheme requires only one stage power conversion circuit to obtain the low-ripple output voltage, and eliminates the need for a RC filter, resulting in a simple system with good performance.

### CROSS-REFERENCE TO RELATED APPLICATIONS

This patent application claims priority to China Patent Application No. 202510039295.1, filed on January 10, 2025 and entitled “Ripple reduction circuit, power supply circuit, and smart meter,” which is hereby incorporated by reference herein as if reproduced in its entirety.

### TECHNICAL FIELD

The present disclosure relates generally to the field of power electronics technologies, and in particular embodiments, to techniques and mechanisms for a ripple reduction circuit, a power supply circuit, and a smart meter.

### BACKGROUND

In power systems, with the further development of power modules, the requirements for power supply are becoming increasingly stringent. For example, in scenario of precision applications, such as application of smart meters, multiple power modules within a smart meter, such as billing modules and information transmission modules, require extremely low-ripple direct current (DC) power supplies. An existing power supply method generally work as follows as shown in FIG. 1. First, an alternating current (AC) input signal is processed by a rectifier and a first-stage power conversion circuit. The first-stage power conversion circuit converts a rectified ripple (having half wave of the AC input signal) into a first DC voltage that still has ripple. Thereafter, the first DC voltage is processed by a second-stage power conversion circuit to obtain a second DC voltage with smaller ripple. This second-stage power conversion circuit is typically a DC-DC converter. Then, the second DC voltage is processed by an RC filter circuit to obtain an output voltage Vo, which is supplied to a power module.

The aforementioned power supply method requires two stages of power conversion circuitry and large RC components to perform ripple reduction process, increasing system complexity, cost and size. Therefore, it is desirable to provide an improved technical solution to overcome the problems in the existing technology.

### SUMMARY

In view of above, an objective of the present disclosure is to provide a ripple reduction circuit, a power supply circuit, and a smart meter to solve the technical problems of complex systems and high costs in the prior art.

According to one aspect of the present disclosure, a ripple reduction circuit is provided that receives a first DC voltage with ripple, and outputs a DC output voltage after performing ripple reduction processing. The ripple reduction circuit includes a power switch, an error amplifier circuit, and a reference voltage generation circuit. A first power terminal of the power switch receives the first DC voltage, and the voltage at its second power terminal serves as the DC output voltage. A control terminal is connected to an output terminal of the error amplifier circuit. The error amplifier circuit controls the power switch based on an error amplification result between the DC output voltage and a reference voltage. The reference voltage generation circuit provides the reference voltage, which is adjusted according to the magnitude of the first DC voltage.

Optionally, a first reference voltage and a second reference voltage are set according to the reference voltage, the first reference voltage and the second reference voltage are set to be greater than the reference voltage, and the first reference voltage is less than the second reference voltage. When the first DC voltage changes to be outside a range between the first reference voltage and the second reference voltage, the reference voltage changes positively following the magnitude of the first DC voltage.

Optionally, in a stable state, the reference voltage is consistent with the value of the output voltage.

Optionally, the reference voltage differs from the minimum value of the first DC voltage by a preset voltage value.

Optionally, the reference voltage generation circuit includes a voltage adjustment circuit, which reduces the reference voltage at a first step rate when the first DC voltage is less than the first reference voltage.

Optionally, within one power frequency cycle, when the first DC voltage is greater than the second reference voltage, the voltage adjustment circuit increases the reference voltage at a second step rate; when the first DC voltage is greater than the first reference voltage and less than the second reference voltage, the reference voltage remains unchanged, wherein the first step rate is greater than the second step rate.

Optionally, the difference between the first reference voltage and the second reference voltage is denoted as a bias voltage, and the value of the bias voltage is greater than a step voltage value of the second step rate.

Optionally, the reference voltage generation circuit includes a comparator circuit, which includes a first comparator and a second comparator. The first comparator compares the first DC voltage and the first reference voltage to generate a first comparison signal, and the second comparator compares the first DC voltage and the second reference voltage to generate a second comparison signal. The voltage adjustment circuit adjusts the magnitude of the reference voltage according to the first comparison signal and the second comparison signal.

Optionally, the comparator circuit further includes a third comparator, which compares the first DC voltage and a third reference voltage to generate a third comparison signal, wherein the third reference voltage is greater than the second reference voltage. When the third comparison signal indicates that the first DC voltage is greater than the third reference voltage, the voltage adjustment circuit increases the reference voltage at a third step rate, wherein the third step rate is greater than the second step rate.

Optionally, the voltage adjustment circuit includes a frequency divider, a counter, and a DAC converter. The frequency divider receives a first clock signal and output signals of the comparator circuit to frequency divide the first clock signal according to the output signals of the comparator circuit to obtain a second clock signal. The counter receives the second clock signal and the output signals of the comparator circuit, and outputs a counting signal characterizing the magnitude of the reference voltage. The counter adjusts the adjustment speed of the counting signal according to the second clock signal and adjusts the adjustment direction of the counting signal according to the comparator signals. The DAC converter receives the counting signal and converts it into a voltage signal as the reference signal.

According to another aspect of the present disclosure, a power supply circuit is provided, which receives an AC input electrical signal, and obtains a first DC voltage after processing the AC input electrical signal by a rectifier circuit and a power conversion circuit. The power supply circuit includes the aforementioned ripple reduction circuit. The ripple reduction circuit receives the first DC voltage, performs ripple reduction processing, and outputs a desired output voltage.

Optionally, the voltage ripple of the desired output voltage is less than or equal to 0.8%.

Optionally, the power conversion circuit includes a first-stage power conversion circuit, which receives a rectified voltage signal, performs power conversion processing, and obtains the first DC voltage; or, the power conversion circuit includes a first-stage power conversion circuit and a second-stage power conversion circuit, where the first-stage power conversion circuit receives a rectified voltage signal, performs power conversion processing, and obtains an intermediate DC voltage, and the second-stage power conversion circuit receives the intermediate DC voltage to obtain the first DC voltage. The first-stage power conversion circuit is a DC-DC conversion circuit, and the second-stage power conversion circuit is a DC-DC conversion circuit.

According to another aspect of the present disclosure, a smart meter is provided that includes the aforementioned power supply circuit and a power consumption module, wherein the power supply circuit is configured to supply power to the power consumption module, and the power consumption module is a functional module of the smart meter.

According to another aspect of the present disclosure, a ripple reduction circuit is provided, which is configured to receive a DC voltage with ripple, perform ripple reduction processing on the DC voltage and output a DC output voltage. The ripple reduction circuit comprises: a power switch, having a first power terminal configured to receive the DC voltage, and a second power terminal, a voltage at the second power terminal being the DC output voltage; an error amplifier circuit, having an output terminal connected to a control terminal of the power switch, wherein the error amplifier circuit is configured to control the power switch based on an error amplification result of an error between the DC output voltage and a reference voltage; and a reference voltage generation circuit, configured to provide the reference voltage, wherein the reference voltage is adjustable according to the DC voltage.

According to another aspect of the present disclosure, a circuit is provided that includes: a power switch, having a first power terminal configured to receive a DC input voltage, and a second power terminal configured to outputting a DC output voltage; and an error amplifier circuit, having an output terminal connected to a control terminal of the power switch, a negative input terminal connected to a reference voltage, and a positive input terminal connected to the second power terminal of the power switch; wherein the reference voltage is adjustable based on the DC input voltage.

According to another aspect of the present disclosure, a power supply circuit is provided that includes a circuit, which includes: a power switch, having a first power terminal configured to receive a DC input voltage, and a second power terminal configured to output a DC output voltage; and an error amplifier circuit, having an output terminal connected to a control terminal of the power switch, a negative input terminal connected to a reference voltage, and a positive input terminal connected to the second power terminal of the power switch; wherein the reference voltage varies based on the DC input voltage compared with a voltage threshold.

With employment of the ripple reduction circuit, the power supply circuit, and the smart meter of the embodiments of the present disclosure, a first DC voltage with ripple undergoes ripple reduction processing by the ripple reduction circuit to obtain a DC output voltage with very low ripple. The ripple reduction circuit includes the power switch and the error amplifier circuit. The first power terminal of the power switch receives the first DC voltage signal, and the voltage at the second power terminal is used as the DC output voltage. The error amplifier circuit receives the DC output voltage and the reference voltage, and controls the switching state of the power switch based on the error amplification result, thereby outputting the desired output voltage. The reference voltage is adjusted in real time according to the magnitude of the first DC voltage. Through the technical solution of this application, the reference voltage adjusts rapidly with the magnitude of the first DC voltage, allowing the switching state of the power switch to adjust accordingly. This maximizes the absorption of the ripple of the first DC voltage by the power switch, resulting in a low-ripple output voltage. The ripple reduction scheme of this application does not require RC or other filtering components, resulting in a simple overall system and good performance.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a circuit diagram of a power supply circuit in existing technology;

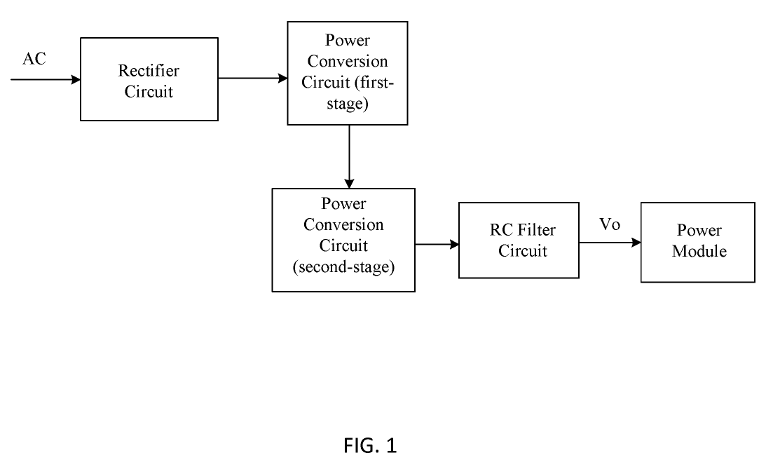

FIG. 2 is a circuit diagram of a power supply circuit according to embodiments of the present disclosure;

FIG. 3 is a circuit diagram of a ripple reduction circuit according to embodiments of the present disclosure;

FIG. 4 is a circuit diagram of a first embodiment of the ripple reduction circuit according to embodiments of the present disclosure;

FIG. 5 is a circuit diagram of a second embodiment of the ripple reduction circuit according to embodiments of the present disclosure;

FIG. 6 is a circuit diagram of a voltage adjustment circuit according to embodiments of the present disclosure; and

FIGS. 7a and 7b are diagrams of operating waveforms according to embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DE TAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Furthermore, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a ripple reduction circuit in power supply and a smart meter. The disclosure may also be applied, however, to a variety of applications where ripple reduction is desirable. Hereinafter, various embodiments will be explained in detail with reference to the accompanying drawings.

Some embodiments of the present disclosure are described in detail below with reference to the accompanying drawings, however, the present disclosure is not limited to these embodiments. The present disclosure covers any substitutions, modifications, equivalent methods and solutions made within the spirit and scope of the present disclosure.

To facilitate a thorough understanding of the present disclosure, specific details are described in detail in the following embodiments of the present disclosure, but those skilled in the art can fully understand the present disclosure without these details.

The present disclosure is described in more detail below by way of examples with reference to the accompanying drawings. It should be noted that the drawings are in a simplified form and use non-precise proportions, and are only used for the purposes to facilitate and clarify the illustration of the embodiments of the present disclosure.

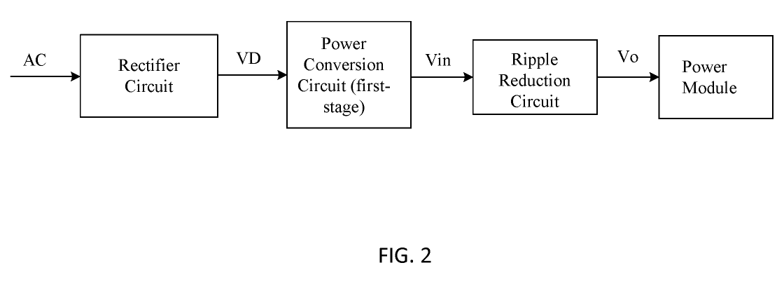

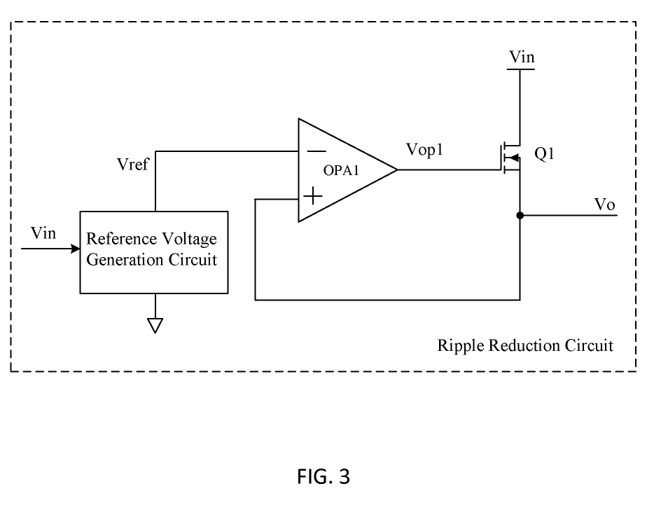

FIG. 2 is a circuit block diagram of a power supply circuit according to embodiments of the present disclosure. FIG. 3 is a circuit block diagram of a ripple reduction circuit according to embodiments of the present disclosure. Referring to FIG. 2, the power supply circuit of the present disclosure receives an alternating current input signal AC, and obtains a first DC voltage Vin after processing the AC signal by a rectifier circuit and a power conversion circuit. A ripple reduction circuit receives the first DC voltage Vin, performs ripple reduction processing, and outputs a desired output voltage Vo. The power conversion circuit herein may include a first-stage power conversion circuit depending on the applications. The first-stage power conversion circuit receives a rectified voltage signal, performs power conversion processing, and obtains the first DC voltage Vin. Alternatively, the power conversion circuit may perform two-stage voltage adjustment, e.g., the power conversion circuit may include a first-stage power conversion circuit and a second-stage power conversion circuit. The first-stage power conversion circuit receives the rectified voltage signal, performs power conversion processing, and obtains an intermediate DC voltage. The second-stage power conversion circuit receives the intermediate DC voltage and obtains the first DC voltage Vin. The first-stage power conversion circuit is a DC-DC converter, which converts the rectified waveform into a DC voltage signal. The second-stage power conversion circuit is a DC-DC converter, which further converts the DC voltage signal into a desired low-ripple DC voltage signal. This embodiment uses a single-stage power conversion circuit as an example for illustration.

As shown in FIG. 3, the ripple reduction circuit of embodiments of the present disclosure may include a power switch Q1, an error amplifier circuit OPA1, and a reference voltage generation circuit. A first power terminal of the power switch Q1 receives the first DC voltage Vin, and the voltage at a second power terminal of the power switch Q1 is the DC output voltage Vo. The control terminal of the power switch Q1 is connected to an output terminal of the error amplifier circuit OPA1. The error amplifier circuit OPA1 controls the power switch Q1 based on an amplification result of the error (referred to as an error amplification result) between the DC output voltage Vo and a reference voltage Vref. The reference voltage generation circuit provides the reference voltage Vref, and the reference voltage Vref is adjusted according to the magnitude of the first DC voltage Vin. The error amplification result is used to control the conduction degree of the power switch Q1 such that the power switch Q1 bears different voltage drops, thereby making the output signal Vo ripple-free or low-ripple. In some embodiments, a first reference voltage Vref1 and a second reference voltage Vref2 may be set according to the reference voltage Vref. The first reference voltage Vref1 and the second reference voltage Vref2 may be set to be greater than the reference voltage Vref, and the first reference voltage Vref1 may be less than the second reference voltage Vref2. When the first DC voltage Vin is outside the range between the first reference voltage Vref1 and the second reference voltage Vref1, the reference voltage Vref changes positively following the magnitude of the first DC voltage (i.e., Vref increases as Vin increases, and decreases as Vin decrease). When the first DC voltage Vin rises to a level greater than the second reference voltage Vref2, the reference voltage Vref increases; when the first DC voltage Vin drops to a level less than the first reference voltage Vref1, the reference voltage Vref decreases.

Specifically, the error amplifier circuit OPA1 may include an error amplifier, which has a first input terminal configured to receive the reference voltage Vref, and a second input terminal connected to the second power terminal of the power switch Q1 to receive the DC output voltage Vo. According to the working principle of the error amplifier, in a stable state, the reference voltage Vref and the output voltage Vo have consistent values (e.g., the same values or values very close to each other).

Through the processing of the ripple reduction circuit of embodiments of the present disclosure, the voltage ripple of the desired output voltage Vo may be less than or equal to 0.8%. The desired output voltage Vo is used to power the power module. For example, the embodiment power supply circuit may be applied in the field of smart meters. The power supply circuit may be used to power functional modules of a smart meter, such as a billing module and an information sending module. In the field of smart meters, an input electrical signal may include ripple caused by switching frequency, ripple caused by power frequency input signal, and ripple caused by a carrier module when load changes. The embodiment power supply circuit, by use of the ripple reduction processing, may reduce the above-mentioned ripple to be within 0.8%, which meets the highest power supply requirement of smart meters. The embodiment ripple reduction circuit is simple to control and has good effect.

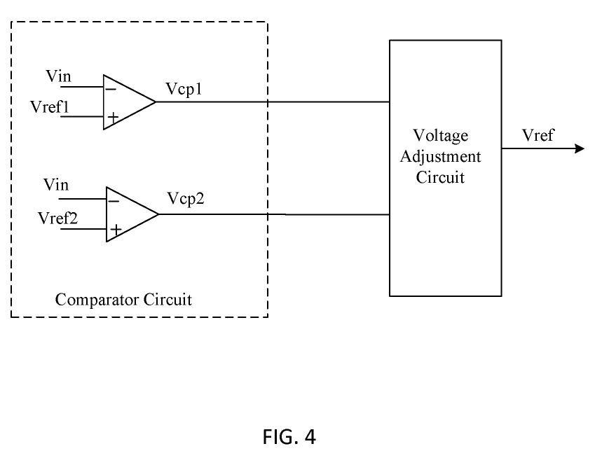

Specifically, FIG. 4 is a circuit diagram of a first embodiment of the ripple reduction circuit according to embodiments of the present disclosure. The ripple reduction circuit of the first embodiment includes a comparator circuit and a voltage adjustment circuit. The initial value of the reference voltage Vref, the first reference voltage Vref1, and the second reference voltage Vref2 may all be provided by a voltage source, which is not shown here. In some embodiments, the comparator circuit may include a first comparator and a second comparator. The first comparator compares the first DC voltage Vin and the first reference voltage Vref1 to generate a first comparison signal Vcp1. The second comparator compares the first DC voltage Vin and the second reference voltage Vref2 to generate a second comparison signal Vcp2. The voltage adjustment circuit is configured to adjust the magnitude of the reference voltage Vref based on the first comparison signal Vcp1 and the second comparison signal Vcp2. In some embodiments, when the first DC voltage Vin is less than the first reference voltage Vref1, the reference voltage may be reduced at a first step rate (e.g., the reference voltage is reduced each time by ΔV1). In some embodiments, within one power frequency cycle, when the first DC voltage Vin is greater than the second reference voltage Vref2, the reference voltage Vref may be increased at a second step rate (e.g., the reference voltage Vref may be increased each time by ΔV2). In some embodiments, when the first DC voltage Vin is greater than the first reference voltage Vref1 but less than the second reference voltage Vref2, the reference voltage Vref remains unchanged. The first step rate is greater than the second step rate, and the second step rate may be the step rate of a DAC converter. When the first DC voltage Vin is less than the first reference voltage Vref1, the reference voltage Vref in this case is too high relative to the first DC voltage Vin. Therefore, the reference voltage Vref needs to be adjusted quickly to ensure that the output voltage is not affected by the rapid change of the first DC voltage Vin, thereby reducing the ripple of the output voltage.

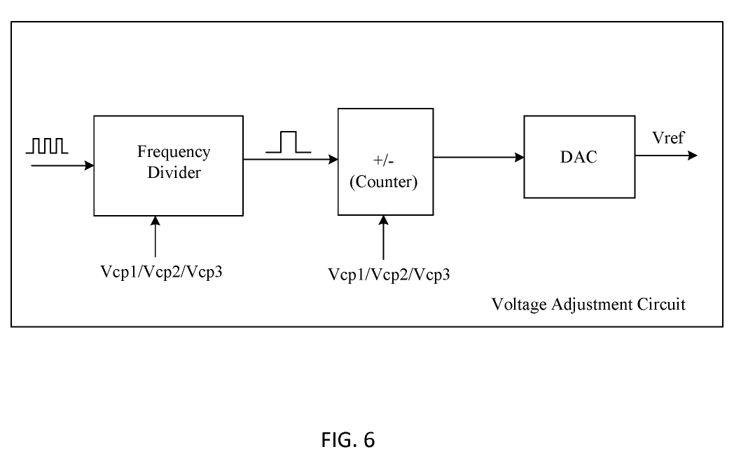

FIG. 6 is a circuit diagram of the voltage adjustment circuit according to embodiments of the present disclosure. As shown, the voltage adjustment circuit includes a frequency divider, a counter, and a DAC converter. The frequency divider is configured to receive a first clock signal, and the output signals Vcp1 and Vcp2 of the comparator circuit, and perform frequency division on the first clock signal according to the output signals of the comparator circuit to obtain a second clock signal. The counter is configured to receive the second clock signal and the output signals Vcp1, Vcp2 of the comparator circuit, and output a counting signal characterizing the magnitude of the reference voltage Vref. The counter is configured to adjust the adjustment speed of the counting signal (i.e., the adjusting the counting signal faster or more slowly) according to the second clock signal, and adjust the adjustment direction of the counting signal (i.e., increasing or decreasing the counting signal) according to the comparator signals (i.e., the output signals of the comparator circuit). The DAC converter is configured to receive the counting signal and convert it into a voltage signal as the reference signal Vref. The embodiment voltage adjustment circuit is a digital adjustment method, which can quickly adjust the value of the reference voltage Vref according to the comparison results. Other circuits that can digitally realize rapid adjustment of the reference voltage value are all within the protection scope of this application. Other digital methods may also be applicable to quickly adjust the value of the reference voltage Vref according to the comparison results.

In some embodiments, the difference between the first reference voltage Vref1 and the second reference voltage Vref2 may be denoted as a bias voltage, and the value of the bias voltage is greater than the step voltage value of the second step rate (e.g., the bias voltage has a value greater than ΔV2). By setting the bias voltage to be greater than the step voltage value of the DAC converter, the comparison results between the reference voltage Vref and the first DC voltage Vin can prevent the reference voltage/signal Vref from being repeatedly adjusted. The above control can eliminate the influence of the system's power frequency ripple.

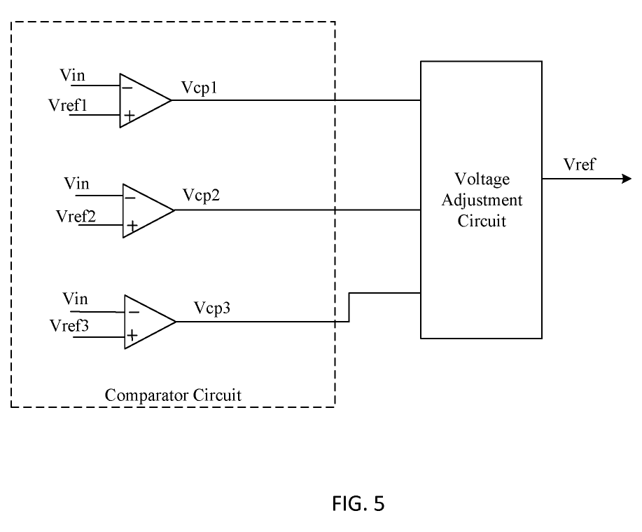

FIG. 5 is a circuit diagram of a second embodiment of the ripple reduction circuit according to embodiments of the present disclosure. The second embodiment adds a third reference voltage Vref3 based on the previous first embodiment. The comparator circuit further includes a third comparator, which compares the first DC voltage Vin and the third reference voltage Vref3 to generate a third comparison signal Vcp3. The third reference voltage Vref3 is greater than the second reference voltage. In some embodiments, the third reference voltage Vref3 may be set to be greater than the maximum value of the ripple of the first DC voltage Vin. When the third comparison signal Vcp3 indicates that the first DC voltage Vin is greater than the third reference voltage Vref3, the voltage adjustment circuit increases the reference voltage Vref at a third step rate (e.g., the reference voltage Vref may be increased each time by ΔV3). The third step rate may be greater than the second step rate (e.g., ΔV3 > ΔV2). That is, when the difference between the first DC voltage Vin and the reference voltage Vref is too large, the reference voltage Vref needs to be increased rapidly. In this case, the voltage adjustment circuit is configured to receive the output signals Vcp1, Vcp2, and Vcp3 of the comparator circuit (as shown in FIG. 6, where the frequency divider and the counter also receive the third comparison signal Vcp3 as input) to control the adjustment speed and direction of the reference signal Vref according to the output signals of the comparator circuit, such that the reference signal Vref is quickly adjusted. This further reduces the system power consumption while eliminating system ripple. The first, second and third reference voltages Vref1, Vref2 and Vref3 may also be considered as different voltage thresholds applied to the comparator circuit, which are used to determine how to adjust the Vref based on the first DC voltage Vin.

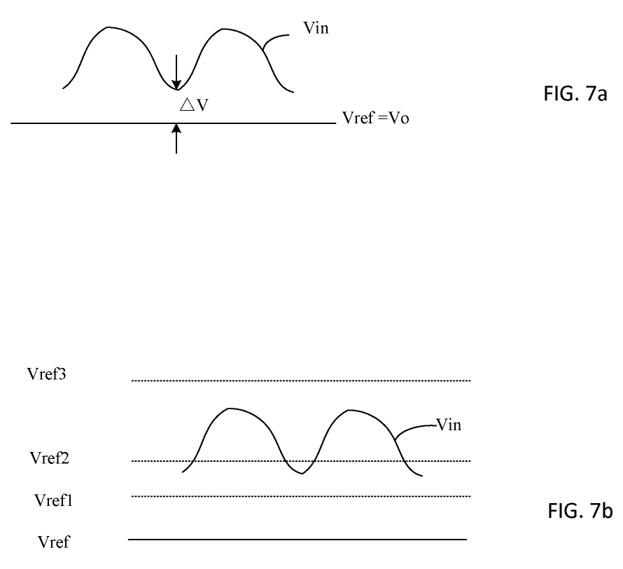

FIG. 7 is a diagram showing operating waveforms according to embodiments of the present disclosure. FIG. 7a is a diagram representing the difference between the reference voltage Vref and the first DC voltage Vin. FIG. 7b is a diagram showing configuration of the relationship between the reference voltage Vref and the first DC voltage Vin. In FIG. 7a, the difference between the minimum value of the reference voltage Vref and the first DC voltage Vin is a preset voltage value ΔV. The preset voltage value ΔV may be any value between 0mV and 30mV. By adjusting the reference voltage Vref according to the embodiments of the present disclosure, the voltage difference between the reference voltage Vref and the minimum value of the first DC voltage Vin is adjusted to be a suitable value, which is neither too large to significantly affect the power supply rejection ratio of the overall circuit, resulting in large output voltage ripple, nor too small to affect the operating state of the power switch. FIG. 7b illustrates the relationship between values of the three reference voltages Vref1, Vref2, Vref3 and the first DC voltage Vin. When the first DC voltage Vin changes to be greater than the third reference voltage Vref3, it indicates that the reference voltage Vref is too small. In this case, the reference voltage Vref needs to be increased quickly so that the difference between the first DC voltage Vin and the reference voltage Vref is within a set range. This can reduce the large power consumption problem caused by the large voltage drop borne by the power switch during the rapid rise of the first DC voltage Vin. When the first DC voltage Vin changes to be lower than the first reference voltage Vref1, it indicates that the reference voltage Vref is too high. In this case, the reference voltage Vref needs to be rapidly reduced to bring the difference between the first DC voltage Vin and the reference voltage Vref within the set range. This prevents large output ripple resulted from unsatisfying system power supply rejection ratio caused by the drop in the first DC voltage Vin. When the first DC voltage Vin varies between the first reference voltage Vref1 and the second reference voltage Vref2, it indicates that the values of the first DC voltage Vin and the reference voltage Vref are appropriate. In this case, the reference voltage Vref remains unchanged, which can eliminate the ripple caused by the power frequency input signal.

The ripple reduction circuit of the application is not limited to the above-mentioned meter applications, and may also be applied to other applications that need ripple elimination in circuits. The first DC voltage signal Vin may be a suitable input signal.

It should be noted that the specific implementations and corresponding drawings provided are merely one way of describing the implementation methods of the present disclosure, and are not intended to limit the specific structure of the implementation scheme of the present disclosure. Various changes or modifications can be made to these implementation schemes without departing from the principle and essence of the present disclosure, but all such changes and modifications fall within the protection scope of the present disclosure.

Although the embodiments are described and illustrated separately above, those ordinarily skilled in the art would recognize that, certain involved common technologies may may be replaced or integrated between the embodiments, and for content not explicitly described in one embodiment, reference may be made to another embodiment that has the content described.

The embodiments described above do not constitute a limitation on the scope of protection of the technical solution. Any modifications, equivalent substitutions, and improvements made within the spirit and principle of the above embodiments should be included within the protection scope of the technical solution.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed:

1. A ripple reduction circuit, which is configured to receive a DC voltage with ripple, perform ripple reduction processing on the DC voltage and output a DC output voltage, the ripple reduction circuit comprising:
a power switch, having a first power terminal configured to receive the DC voltage, and a second power terminal, a voltage at the second power terminal being the DC output voltage;
an error amplifier circuit, having an output terminal connected to a control terminal of the power switch, wherein the error amplifier circuit is configured to control the power switch based on an error amplification result of an error between the DC output voltage and a reference voltage; and
a reference voltage generation circuit, configured to provide the reference voltage, wherein the reference voltage is adjustable according to the DC voltage.

2. The ripple reduction circuit of claim 1, wherein a first reference voltage and a second reference voltage are set based on the reference voltage, the first reference voltage and the second reference voltage are greater than the reference voltage, and the first reference voltage is smaller than the second reference voltage; and
when the DC voltage changes to be beyond a range from the first reference voltage to the second reference voltage, the ripple reduction circuit is configured to change the reference voltage positively with the DC voltage.

3. The ripple reduction circuit of claim 2, wherein the reference voltage generation circuit comprise a voltage adjustment circuit, and when the DC voltage is less than the first reference voltage, the voltage adjustment circuit is configured to reduce the reference voltage at a first step rate.

4. The ripple reduction circuit of claim 3, wherein, within one power frequency cycle,
when the DC voltage is greater than the second reference voltage, the voltage adjustment circuit is configured to increase the reference voltage at a second step rate;
when the DC voltage is greater than the first reference voltage and less than the second reference voltage, the reference voltage remains unchanged; and
the first step rate is greater than the second step rate.

5. The ripple reduction circuit of claim 4, wherein a bias voltage being a difference between the first reference voltage and the second reference voltage has a value that is greater than a step voltage value of the second step rate.

6. The ripple reduction circuit of claim 3, wherein the reference voltage generation circuit comprises a comparator circuit including a first comparator and a second comparator;
the first comparator is configured to compare the DC voltage and the first reference voltage to generate a first comparison signal;
the second comparator is configured to compare the DC voltage and the second reference voltage to generate a second comparison signal; and
the voltage adjustment circuit is further configured to adjust the reference voltage based on the first comparison signal and the second comparison signal.

7. The ripple reduction circuit of claim 6, wherein the comparator circuit further comprises a third comparator configured to compare the DC voltage and a third reference voltage to generate a third comparison signal, the third reference voltage being greater than the second reference voltage; and
when the third comparison signal indicates that the DC voltage is greater than the third reference voltage, the voltage adjustment circuit is further configured to increase the reference voltage at a third step rate, the third step rate being greater than the second step rate.

8. The ripple reduction circuit of claim 7, wherein the voltage adjustment circuit comprises a frequency divider, a counter, and a DAC converter;
the frequency divider is configured to receive a first clock signal and output signals of the comparator circuit, and perform frequency division processing on the first clock signal according to the output signals of the comparator circuit to obtain a second clock signal;
the counter is configured to receive the second clock signal and the output signals of the comparator circuit, output a counting signal characterizing a magnitude of the reference voltage, adjust an adjustment speed of the counting signal according to the second clock signal, and adjust an adjustment direction of the counting signal according to the output signals of the comparator circuit; and
the DAC converter is configured to receive the counting signal and convert the counting signal into a voltage signal as the reference voltage.

9. The ripple reduction circuit of claim 6, wherein the voltage adjustment circuit comprises a frequency divider, a counter, and a DAC converter;
the frequency divider is configured to receive a first clock signal and output signals of the comparator circuit, and perform frequency division processing on the first clock signal according to the output signals of the comparator circuit to obtain a second clock signal;
the counter is configured to receive the second clock signal and the output signals of the comparator circuit, output a counting signal characterizing a magnitude of the reference voltage, adjust an adjustment speed of the counting signal according to the second clock signal, and adjust an adjustment direction of the counting signal according to the output signals of the comparator circuit; and
the DAC converter is configured to receive the counting signal and convert the counting signal into a voltage signal as the reference voltage.

10. The ripple reduction circuit of claim 1, wherein the reference voltage and the DC output voltage are consistent in a stable state.

11. The ripple reduction circuit of claim 1, wherein the reference voltage differs from a minimum value of the DC voltage by a preset voltage value.

12. A power supply circuit configured to receive an AC input signal, and process the AC input signal by a rectifier circuit and a power conversion circuit to obtain a DC voltage, the power supply circuit comprising the ripple reduction circuit of claim 1;
wherein the ripple reduction circuit is configured to receive the DC voltage, perform ripple reduction processing on the DC voltage, and output the DC output voltage.

13. The power supply circuit of claim 12, wherein voltage ripple of the DC output voltage is less than or equal to 0.8%.

14. The power supply circuit of claim 12, wherein,
the power conversion circuit comprises a first-stage power conversion circuit configured to: receive a rectified voltage signal of the AC input signal, and perform power conversion processing on the rectified voltage signal to obtain the DC voltage; or
the power conversion circuit comprises a first-stage power conversion circuit and a second-stage power conversion circuit, the first-stage power conversion circuit being configured to: receive a rectified voltage signal of the AC input signal, and perform power conversion processing on the rectified voltage signal to obtain an intermediate DC voltage, and the second-stage power conversion circuit being configured to receive the intermediate DC voltage to obtain the DC voltage;
the first-stage power conversion circuit is a DC-DC conversion circuit, and the second-stage power conversion circuit is a DC-DC conversion circuit.

15. A smart meter, comprising the power supply circuit of claim 12 and a power consumption module, wherein the power supply circuit is configured to supply power to the power consumption module, which is a functional module of the smart meter.

16. A circuit comprising:
a power switch, having a first power terminal configured to receive a DC input voltage, and a second power terminal configured to output a DC output voltage; and
an error amplifier circuit, having an output terminal connected to a control terminal of the power switch, a negative input terminal connected to a reference voltage, and a positive input terminal connected to the second power terminal of the power switch;
wherein the reference voltage is adjustable based on the DC input voltage.

17. The circuit of claim 16, further comprising a comparator circuit configured to receive the DC input voltage for comparison;
wherein the circuit is configured to change the reference voltage positively with the DC input voltage when the detecting, by the comparator circuit, that the DC input voltage is outside a range defined by a first reference voltage and a second reference voltage, the first reference voltage and the second reference voltage are determined based on and greater than the reference voltage, and the first reference voltage is smaller than the second reference voltage.

18. The circuit of claim 17, wherein the circuit is configured to:
decrease the reference voltage when detecting, by the comparator circuit, that the DC input voltage is less than the first reference voltage;
increase the reference voltage when detecting, by the comparator circuit, that the DC input voltage is greater than the second reference voltage; and
keep the reference voltage unchanged when detecting, by the comparator circuit, that the DC input voltage is greater than the first reference voltage and less than the second reference voltage.

19. The circuit of claim 17, further comprising a frequency divider, a counter, and a DAC converter;
wherein the frequency divider is configured to receive a first clock signal and output signals of the comparator circuit, and perform frequency division processing on the first clock signal according to the output signals of the comparator circuit to obtain a second clock signal;
the counter is configured to receive the second clock signal and the output signals of the comparator circuit, and output a counting signal representing a magnitude of the reference voltage; and
the DAC converter is configured to receive the counting signal and convert the counting signal into the reference voltage.

20. A power supply circuit comprising a circuit that includes:
a power switch, having a first power terminal configured to receive a DC input voltage, and a second power terminal configured to output a DC output voltage; and
an error amplifier circuit, having an output terminal connected to a control terminal of the power switch, a negative input terminal connected to a reference voltage, and a positive input terminal connected to the second power terminal of the power switch;
wherein the reference voltage varies based on the DC input voltage compared with a voltage threshold.
